(19) United States
(12) Patent Application Publication
(10) Pub. No.: US 2007/0069794 A1
(43) Pub. Date: Mar. 29, 2007

(54) System and method for generating self-aligned clock signals for consecutive circuit operations

(75) Inventor: Mehmet Ali Tan, Irvine, CA (US)

Correspondence Address: STEVENS LAW GROUP, P.O. BOX 1667, SAN JOSE, CA, 95109, US

(73) Assignee: ESS Technology, Inc., Fremont, CA (US)

(21) Appl. No.: 11/238,421

(22) Filed: Sep. 28, 2005

(51) Int. Cl. G06F 1/04

(52) U.S. Cl. 327/291

(57) ABSTRACT

A system and method of generating a clock signal are provided for driving a plurality of consecutive circuit phase operations. The method includes generating a clock signal, transmitting the clock signal to one circuit phase operation, and transmitting another clock signal to a previous circuit phase operation. A circuit configured according to the invention can clock a plurality of consecutive circuit phase operations with a single master clock, where each circuit phase generates a clock signal to clock a previous phase, obviating connections from a master clock to multiple phases.

### BACKGROUND

In large sampled data circuits, the clock skew that is caused by long clock lines may cause problems for sampling in correct time. The clock lines must be routed and repeated with great care, imposing difficulties in design and resulting in a complicated and problem prone hardware. In conventional systems, the margins between clock signals must be kept larger than the possible skew.

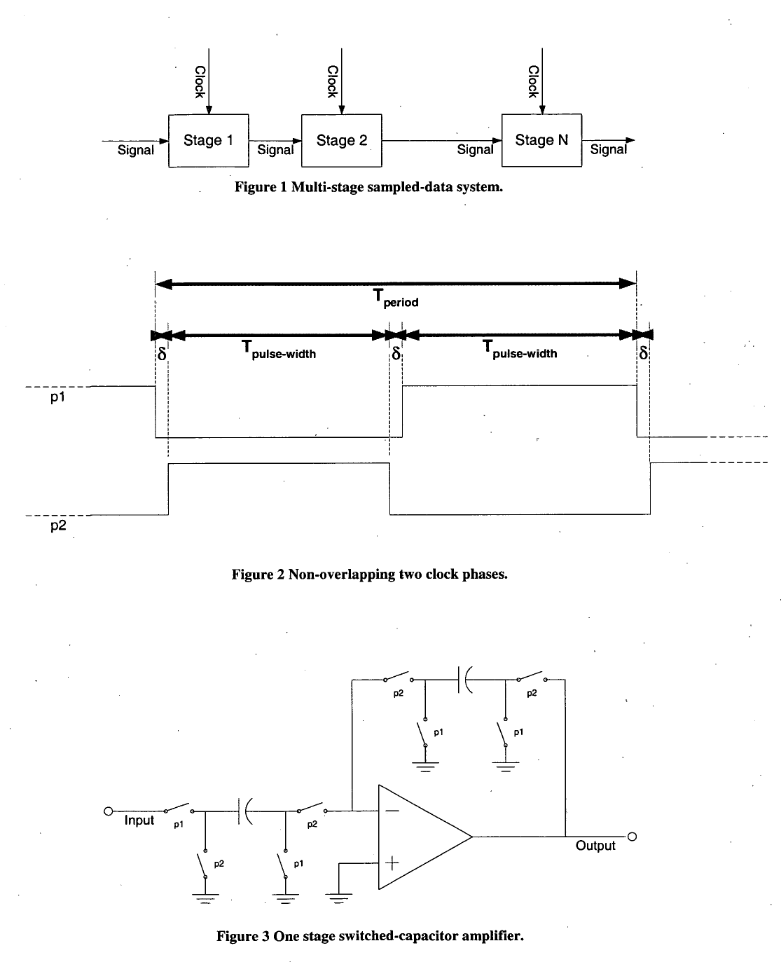

Referring to FIG. 1, cascaded N-stage sampled-data circuits are illustrated. Each phase receives a signal from a prior stage where operations are performed, where stage 1 may receive an initial input signal and perform an operation at stage 1 at a speed according to the clock pulse received. Stage 2 may be another operation that receives the processed signal output from stage 1, and the output of stage 2 would be transmitted to the next stage after the process of stage 2 performed in time with the clock input is complete. Each stage may be part of an entire chain of sampled data circuits, for example sample-and-hold (S/H), switched-capacitor (SC) amplifier, pipelined analog-to-digital converter (ADC), or other circuits that perform signal processes. Through out this description, circuit processes and circuits that perform these processes are used interchangeable as entities, but essentially refer to circuits that perform operations in an integrated circuit whether utilizing hardware circuitry, software or firmware, or other integrated circuit components.

As in conventional systems, the clocks in FIG. 1 are generated from a master clock (or time base) and have non-overlapping phases. For simplicity, let us consider a two-phase system. In fact, each clock signal is a bus of two signals, let it be called phases, e.g. p1 and p2, where phase 2 is an inverted version of phase 1, or vice versa. Throughout this discussion, phases time periods where an operation is active. During these phases, when each phase is active, the circuit topology is periodically altered. The phases, as shown in FIG. 2, are non-overlapping in order to ensure a certainty in alternating circuit topology.

These phases are used to activate the components used to perform operations at a particular phase. As an example for discussion, a stage having a switched-capacitor (SC) amplifier is illustrated in FIG. 3. The switches are closed according to the active phases of p1 and p2. Thus, the clock signals dictate the internal operation speed of the SC circuit.

According to the timing shown in FIG. 3, during the non-overlapping time intervals, δ, all switches are open. The switches indicated by control phase p1 are closed while the p1 signal is HIGH, and open during other times, and p2 switches are closed during p2 signal is HIGH and open during other times This circuit samples the input signal at the end of p1 phase and holds the calculated output during p2 phase. There exists a finite settling time of the transient response of the circuit topology during p2 phase. Therefore, the output signals get more and more close to the final value (t→∞). Therefore, the valid output value is obtained toward the end of the p2 phase.

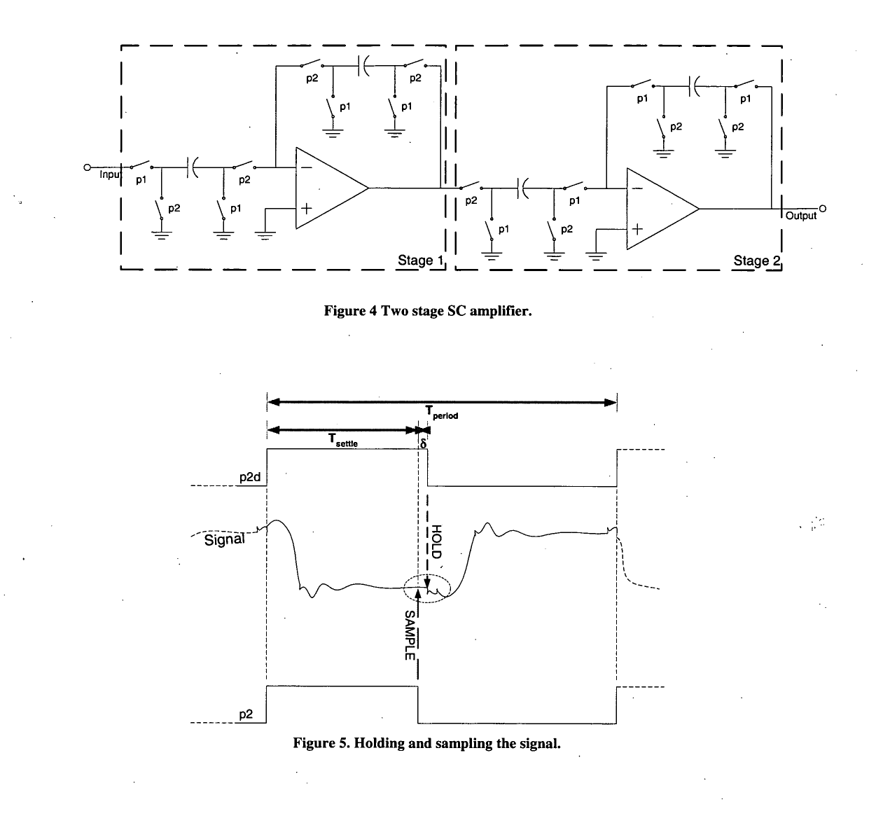

The operations become complicated when two operational blocks or phases are cascaded together, such as that illustrated in FIG. 4. In this example, two sampled-data circuits may be combined in a series, or cascaded. In operation of these sample and hold circuits, the subsequent phase samples while the preceding section holds. This operation is repeated in the sample and hold process, and the previous sample and hold process picks up a new sample, while the subsequent sample and hold process is sampling the old sample. Therefore, in order for these circuits to operate properly, the sampling phase of the subsequent section must be the same as the holding phase of the previous section as shown in FIG. 5. They must not overlap, or the ultimate output signal quality will be compromised.

Nevertheless, this circuit has a problem when the end of the hold phase (p2) of the Stage 1 coincides with the sampling phase (p2) of the Stage 2. In such circuits, any uncertainty may cause a wrong value of the Stage 1 output (a value that occurs in transition to zero) to be sampled by the Stage 2 input. In prior art systems, the holding phase of the Stage 1 is held somewhat longer in time, longer than the time period δ as shown in the FIG. 5, so that the sampling phase of the Stage 2 is delayed. In this conventional fix, this delay is called p2d (delayed), and the sampling phase of the Stage 2 is p2 as shown in FIG. 5.

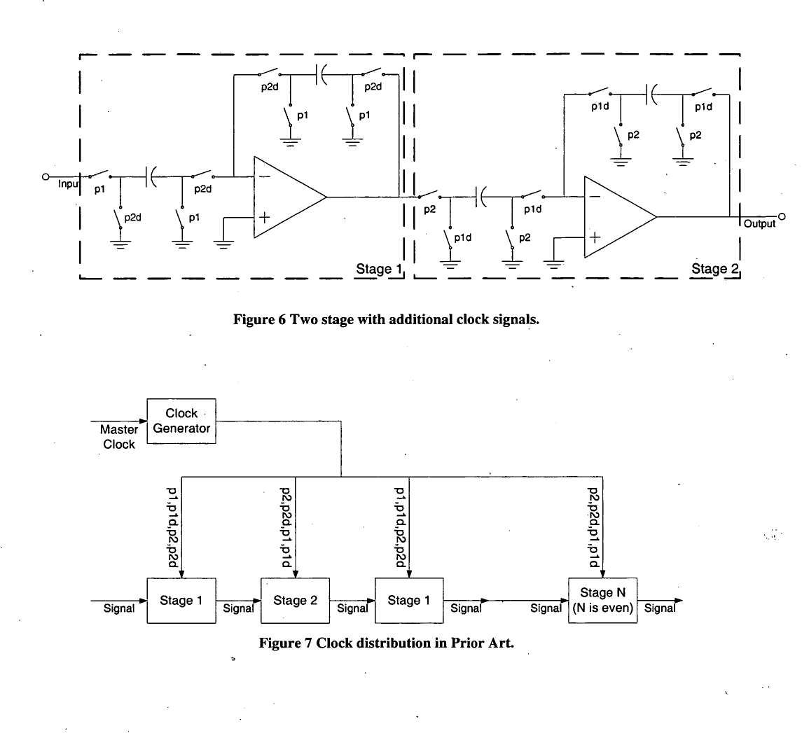

The resulting more complicated two-stage complete circuit must then be designed as shown as in FIG. 6. Note that for the same reason, considering the previous cascaded section preceding these two, stages, along with the following stages, the p1 phase should be taken care of by creating another clock signal p1d, which has somewhat longer (as much as δ also) pulse width. In FIG. 5, Tₛₑₜₜₗₑ is the necessary time required for the signal at the first stage output to settle within an error margin of the final value (i.e., t→∞). For example, in an operation where a comparator is followed by an amplifier operation, there is a period for each operation, and there remains in between a difference of time between these two operations that accounts for the entire active pulse of the clock. The more time demanded by operations, the less time tolerance remains between these operations. In multiple consecutive operations, the duty cycles of each operation crowds the precious little time allowed in a clock period. For example, at 40 megahertz, the limit of a particular active clock pulse is 12.5 nanoseconds. The frequency of the system is related to 1/(δ+T_{C}+T_{A}), where δ is the time between operations, T_{C} is the time to perform the comparator operation, and T_{A} is the time required to perform the amplifier operation. For example, if the delta is approximately 4 nanoseconds and the comparator time is approximately 6 nanoseconds, this leaves 2.5 nanoseconds for the amplifier operations. This is a very high demand on a system. Again, when multiple operations are performed consecutively, then the delta increases, leaving less time for actual circuit operations.

This problem is exacerbated by the need for more speed in a system. If the duty cycle for any operation is reduced, then more power is demanded. For example, if the time for comparator operations is reduced, more power is required for the comparator operations to complete in a shorter amount of time. Similarly, if amplifier operations are demanded in a shorter amount of time, then the power required to complete the amplifier operation is increased. Generally, if you double the amplifier speed (reduce the duty cycle), you quadruple the power required to perform the amplification operation. Thus, a developer does not get anything for free. If speed is required, then there must be a balance struck between power consumption and speed.

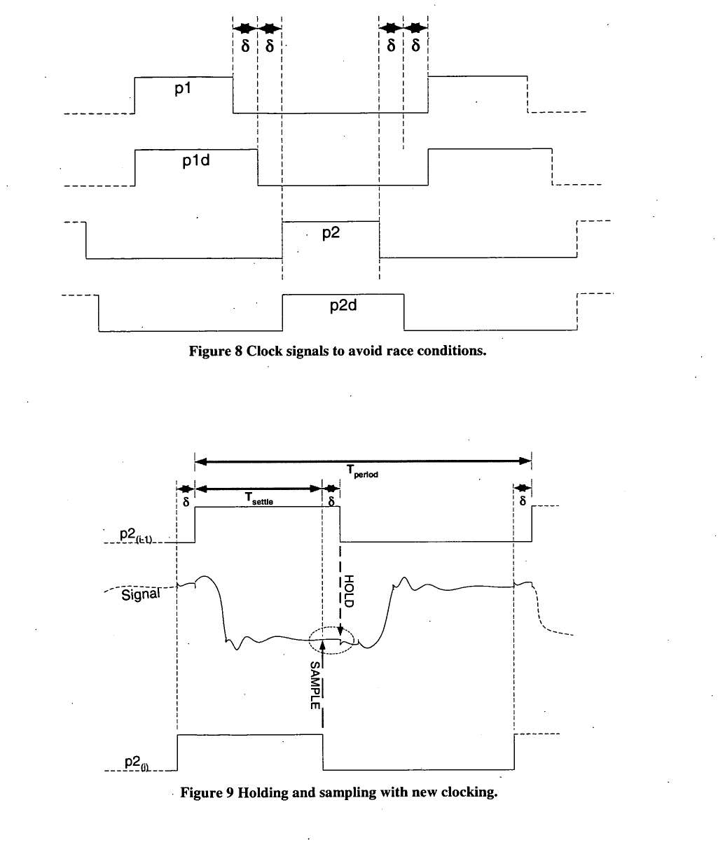

Because this timing solution just concerns two consecutive stages, and because the holding and sampling phases are alternated from one section to the next one, the same group of clock signals, i.e., p1, p1d, p2, p2d, can be sent to alternating stages, as shown in FIG. 7. Thus, the delays are perpetuated through a cascaded series of components, Stages 1-N. It is important to note that the signal order is altered for the alternating stages due to the fact that the sampling phase for a given stage is the holding phase for the previous stage. Also it is important to note that there is now a 2δ non overlapping time between p1 and p2, because there must be no overlapping time difference or δ between p1d and p2. Also, there can be no time overlap or δ between p2d and p1. This is shown in FIG. 8. As can be seen, the active phase of the clock cycles are greatly reduced by these additional time delays.

First of all, one problem with this scheme is that it requires generation and routing of two more clock signals, i.e., p1d and p2d in addition to two phases p1 and p2. These signals must be routed with wires on a chip, which take up precious integrated circuit chip space and cause further delays by the distance traveled by the clock signal on the wires. Also, two consecutive stage clock signals must be delivered with limited skew in between them. This implies that all the even stage clocks must have the same delay within margin of δ, the time difference between the p1 and p1d signals falling edges, as well as the non-overlapping time of δ between p1d and p2. When the entire system grows, adding more cascaded components in series, this requirement becomes more and more difficult to meet, since the routing of wires as far as 500 microns, possibly the length of an entire chip, becomes necessary. This is more difficult in this case, where the number of clock signals is twice the number of phases.

The result is that δ essentially increases as you add consecutive operations in a circuit. One conventional solution is to add clock drivers to drive alternate circuit operations as discussed above. This requires more power. This also adds more length to the wire connections among the clock drivers and the separate circuit operations, which means more precious chip space is taken up. Again, there is the trade off between speed, integrated circuit area used, power consumed, and overall quality of performance. If the circuit operations of the system, such as the comparator and amplifier for example, had sufficient time to operate at the same high speed, then high speed could be accomplished without significant demand for more power at a high speed. What has been observed in conventional systems, however, is that δ takes up a significant amount of time. This is particularly true when more circuit operations are lined up in a circuit using conventional clocking configurations and techniques. Fore example, if multiple consecutive operations for signal processing are lined up on a chip using conventional clocking techniques, clock wires that take up chip area can run the length of an entire chip.

The result is a crowded integrated circuit chip that consumes a significant amount of power, or that may perform too slowly or perform poorly, giving poor processing output signals.

Thus, there exists a need in the art for an improved clocking system and method that overcomes these shortcomings of the prior art, particularly by keeping the number of clock signals minimum, and that avoids race conditions in clocks. As will be seen, the invention accomplishes this in an elegant manner.

### DETAILED DESCRIPTION

The invention is directed to a new way of routing clocks in a series of electronic circuit operations, such as for example sampled-data circuits. It simplifies circuit design by self aligning the clock signals within a system having a cascaded series of operational stages. This is done by sending a master clock signal to a later occurring, or in fact the last occurring, operational stage, and generating clock signals from each stage after that stage's operation has completed, and then transmitting another clock signal to a previously occurring operational stage in the system. This eliminates the need for large margins of time between clock cycles required in conventional systems, and uses the minimum number of clocks required to drive a series of consecutive circuit operations. In prior art systems, the number of clock signals required was twice the number of phases used, where the reason is primarily to prevent an overlap of operations that occur consecutively in time. A circuit configured according to the invention uses only as many clock signals the number of phases of circuit operations. This is because the circuit would prevent overlap of operations that occur consecutively in time by the inherent operation of its design. A circuit configured according to the invention results in an overall simplified integrated circuit design, requiring much less area for wiring compared to prior art configurations. More importantly, the time margin between and during the phases can be reduced, giving a developer a wide margin of time in which to operate components within an operational block. This allows for a faster operating system with significantly reduced errors and without substantial power requirements, all with an actual reduction in required space on the integrated circuit chip.

The invention can be applied in any sampled-data circuits, such as, but not limited to, the switched capacitor circuits like switched-capacitor fixed- or programmable gain amplifiers, analog-to-digital converters, digital-to-analog converters, entire data path of sampled data systems, such as in CMOS image sensors and other sampled data circuits. It can be further be used in other sampled-data circuits like switched-current circuits. Furthermore, the invention may apply to any circuit configuration where multiple clocking signals are required for various components that occur cascaded in a series and that operate consecutively, where the prevention of overlap of operation timing is desirable. Those skilled in the art will understand that the essence, the spirit and scope of the invention extends to many applications were such functionality is useful, and the invention is defined by appended claims and all equivalents.

According to the invention, a clocking system and method are provided for use in an integrated circuit having a plurality of consecutive circuit phase operations. The clocking system includes a clock driver configured to generate a clock signal. In contrast to the prior art, this single clock signal can operate to time a cascaded series of circuit operation blocks with substantially reduced time delay. The clock driver is configured with a clock output configured to transmit the clock signal to one of the blocks that performs a circuit phase operation. In operation, the circuit phase operation receives this clock signal, and performs its operation according to the speed of this clock signal. Then, after the operation is completed, the clock phase operation, configured with a circuit phase operation clock output, transmits another clock signal to a previous circuit phase operation, one that operates earlier in time. This is the genius of the invention, where the clock signals are generated from the end of a series of operations. This was discovered to be more useful and efficient manner to clock a series of cascaded stages of operation, in contrast to prior art approaches that simultaneously clocks operational blocks to each individual block occurring in the series, or alternatively from the beginning to the end of the series. According to the invention, for example, if two sample and hold circuits were cascaded together, the clock signal from the clock output would be received by the operational block that operates on a sample later in time. When the operational block has completed its operation, then it transmits a second clock signal from this second operational block to the first operational block.

Such a clocking system is adaptable to a series of consecutive circuit phase operations that operate consecutively in time, and each phase may contain a different type of operation, such as a sample and hold, and amplifier, or other operation. In such a configuration, the clock output is configured to transmit the clock signal to the last consecutive circuit phase operation, and each circuit phase includes an operation clock output configured to transmit a clock signal to a previous circuit phase.

In one embodiment, a clocking system is provided where the clock driver is configured to generate a first clock signal and a corresponding first inverted clock signal. The clock output is configured to transmit the first clock signal and first inverted clock signal to one circuit phase operation. The circuit phase operation clock output is configured to transmit a second clock signal and a second inverted clock signal to a previously occurring circuit phase operation occurring within the plurality of consecutive circuit phase operations. In a system of multiple consecutive operational blocks, a clock driver may be configured to generate a first clock signal and a corresponding first inverted clock signal, wherein the clock output is configured to transmit the first clock signal and first inverted clock signal to the one circuit phase operation. The circuit phase operation clock output is configured to transmit a second clock signal that is an inverted version of the first clock signal and a second inverted clock signal that is an inverted version of the first inverted clock signal to a previously occurring circuit phase operation in the plurality of consecutive circuit phase operations. Thus, each phase can generate a secondary clock signal after the operation is completed in that stage, where the previous circuit phase operation operates previously in time from the later circuit phase operation, but the later circuit phase operation generates the clock signal that governs the timing of operation of the previous phase. In a preferred embodiment, the current phase operation is configured to generate a secondary clock signal to a previous circuit phase operation after the completion of the operation of the one circuit phase operation.

Thus, beginning from the later occurring operational block, or phase, the initial clock is received by this first phase, and the operation of this first phase is governed by the initial clock signal. The first phase circuit has a clock output that is configured to transmit a secondary clock signal to a second circuit phase operation that operates previously in time in relation to the operation of the first or consecutive circuit phase operations. In a preferred embodiment, the clock output from the first phase is configured to transmit a second clock signal to the second circuit phase operation after the completion of the operation of the first circuit phase operation to prevent any overlap in operation between the two adjacent phases, where they operate consecutively in time, first the second phase, then the first phase.

To prevent confusion, it is important to note that this description at times refers to later occurring phases as first phases, but only because of the peculiarity of the invention. This is because the clocking system operates contrary to conventional thinking, where clock operations begin with the operational phases that occur first in time in the system operations. According to the invention, the clocking system operates opposite of prior art systems, where the clock timing is established at the later stages, if not the final stage of a cascaded series of operational blocks. Continuing, the second phase generates another secondary clock output, where the second phase further includes a second circuit phase operation clock output configured to transmit a third clock signal to a third circuit phase operation that occurs previous to the second circuit phase operation.

According to the invention, a fourth, fifth and further phases may be added that occur previously in time, and the clock timing is preserved, because the timing of any particular phase is governed by the operations of the subsequent phase. Therefore, there is no overlap of duty cycles, and the circuit can operate without error. Also, the speed of the circuit can be increased without the worry of overlap among the phases. In prior art systems, overlap would occur, because the active period of any one operational block would be greatly limited by the delays required to prevent overlap. Thus, according to the invention, more time is allotted to complete the operations of any one operational block without the crowding of delay periods. And, as a result, overall speed of the system operation can be increased without substantial sacrifice on quality or expenditure of power.

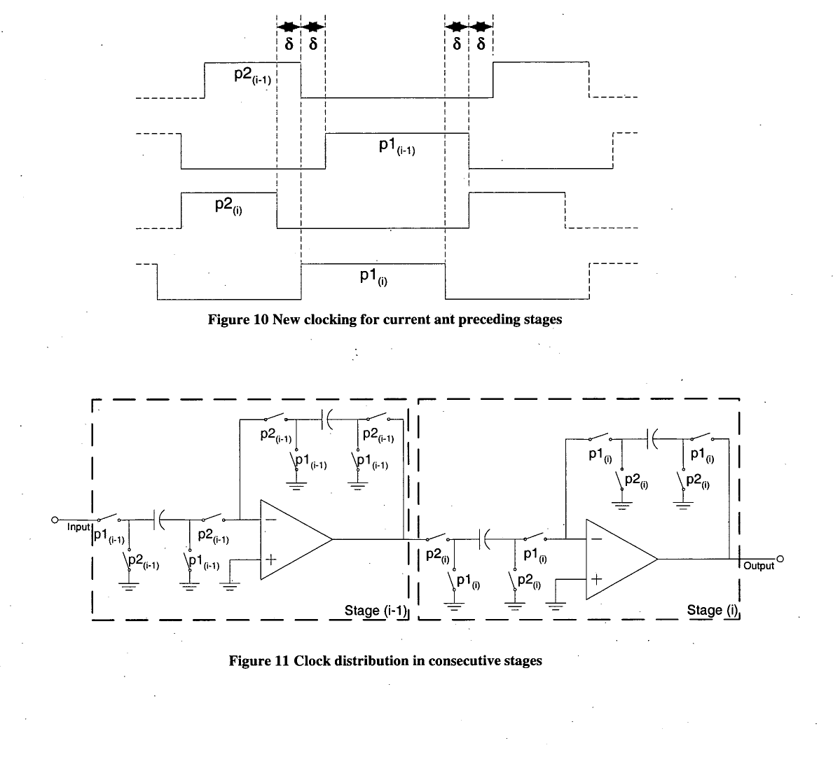

Another problem in prior art circuits is a race condition. In operation, there is only one requirement to avoid race condition that can occur between holding time and sampling time. This is that the sampling by the following stage must occur over a finite time before the holding time of the previous stage. This only matters when the falling edges of the clocks are taking place. The rising edges do not need to be concurrent. According to the invention, this circumstance facilitates the clocking of consecutive stages by delaying the phases by the same small amount, which naturally occurs by the loading and repeating of the consecutive phases. The invention eliminates the need for the additional clock cycles, such as p1d and p2d discussed above. The new clocking scheme derived according to the invention is illustrated in FIG. 9. Note that the p2 (holding phase) of the previous stage (i-1), is just a delayed version of p2 (sampling phase) of the current stage (i). The same apply to the p1 phases as well. Accordingly, the both phases can be depicted as in FIG. 10. According to the invention, the additional delays required from phase to phase to prevent overlap are no longer necessary, and more time is available for individual phases to complete their functions. From stage to stage, the δ, or delay, demands are significantly reduced or eliminated as more stages are added. The risk of overlap is significantly reduced or eliminated, so the corresponding delays associated with such risk are likewise significantly reduced or eliminated.

The distribution of the novel clock corresponding to an example of a sample and hold circuit configured according to the invention is shown in FIG. 11. As can be seen, the clock inputs to Stage (i) are the p1 and p2, initial clock signals, from a master clock communicating with this later stage of the process. The corresponding p1 and p2 in Stage (i-1) are corresponding delayed clock signals emanating from Stage (i). The active edge of this corresponding clock signal is timed at i-1 relative to the clock signal from Stage (i), where the signal to Stage (i-1) provides an active clock after the completion of the operations of Stage (i). As a result, this circuit that is configured according to the invention prevents any overlap of timing between these two sample and hold phases of operation. This is but one example of an operational block configured according to the invention, where a later stage, Stage (i), receives an initial clock signal, and then transmits a secondary signal to a previously occurring stage, Stage (i-1). In a preferred embodiment, the corresponding secondary signal is an inverted version of the initial clock signal. This is illustrated in FIG. 11, where clock signals p1₍ᵢ₎ and p2₍ᵢ₎ of Stage (i) correspond to p2₍ᵢ₋₁₎ and p1₍ᵢ₋₁₎ of Stage (i-1) respectively. As a further example, if a third stage were added that proceeded Stage 2, the third stage being Stage (i-2), it would receive secondary signals from Stage (i-1), where the clock signals corresponding clock signals p1₍ᵢ₋₂₎ and p2₍ᵢ₋₂₎ of Stage (i-2) would correspond to clock signals p2₍ᵢ₋₁₎ and p1₍ᵢ₋₁₎ of Stage (i-1) respectively. Again, in a preferred embodiment, the p1 and p2 signals of the third stage, Stage (i-2), transpose corresponding to the second stage, Stage (i-1).

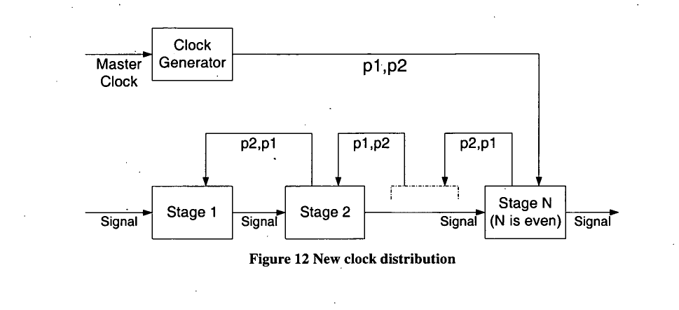

A broader illustrating of the novel clock routing of a broader system as shown in the FIG. 12. Again note that, in a preferred embodiment, the alternate stages receive alternate clock signals p1 and p2 from previous stages occurring in the cascaded series. Thus, the master clock includes a clock generator that generates initial clock signals p1 and p2, which are inverter versions of each other. These are transmitted to Stage N, the final in a series of cascaded stages. The total number of stages may be an even or odd number, but this example illustrates that there is an even number of stages, where Stage N receives clock signals p1 and p1. In turn, after the process of Stage N is completed, clock signals p2 and p1 are transmitted to a previous stage, which are transposed versions of the initial signals p1 and p1. This clocking process continues down the line in reverse order of circuit operation, where a transposed version of clock signals are transmitted from each stage to a previous stage until Stage 1 receives clock signals p2 and p1 respectively. In this broad view, Stage 1 receives an input signal, process it according to the clock signals received from Stage 2, then transmits an output signal to Stage 2. Stage 2 then processes the output signal received from Stage 1 according to clock signals p1 and p1 received from a previous stage. The output from Stage 2 is then transmitted to a subsequent stage (not shown). This process continues until Stage N receives a signal that is the result of the input signal being processed by each stage along with clock signals p2 and p1, which are transposed or inverted versions of the clock, signals received by a previous stage (not shown).

The result is a processed output signal from Stage N. According to the invention, the processing of the signal proceeds in a temporal manner from Stage 1 to Stage N, but the location of the active regions of the clock signals are determined by and emanate from later occurring clock signals in the process. Stage N receives the initial clock signal from the master clock, and the clock signals for the earlier occurring stages perpetuates backwards toward the first stage if signal processing operation, Stage 1. Utilizing the invention, circuit developers can cascade series of components without concern for overlap of any particular operation stage in the chain of operation with another operation stage. The resulting integrated circuit can operate more efficiently, particularly at higher speeds than prior art systems, and produce a processed result at a higher quality. For example, any signal processing circuit that has consecutive operations that each receives an input from a previous stage and generates an output signal to a subsequent stage can benefit from the invention.

In one particular implementation, a pixel sensing device sends a signal to a sample and hold circuit, which samples the input from the pixel sensing device and generates a sampled output. This output is received by a programmable amplifier that generates an amplified output signal for an analog to digital converter, which then generates a digital output for further processing by digital components. Along this chain of operations, according to the invention, a clock signal from a master clock can be transmitted to a later stage in the circuit, such as the analog to digital converter, the digital components, or other components for example. The initial component that receives the initial signal from the master clock can then run its operation according to the timing of the clock signal. Then according to the invention, it can transmit a clock signal to a previous stage. In a preferred embodiment, this clock signal provides two signals, where one is an inverted version of the other. Furthermore, the signals correspond to the initial master clock signal in that they are transposed as discussed above, e.g. p1, p2 is transmitted from the later stage to the previous stage in the order of p2, p1. The previous stage, such as the programmable amplifier for example, can then perform its operation according to the clock signal received from the later stage, and then transmit another clock signal to a previous stage in the same manner after its operation is complete. This manner of clocking operation would continue until the final clocking component, which is the first operational component (such as the pixel sensing device), receives its clock signal, and then performs its operation. The clocking cycle then repeats its process, over and over again as the system operates.

The invention is described in the context of a novel system and method for a clock distribution and clocking scheme for sampled-data circuits. It is new by avoiding additional clock signals p1d and p2d (In general, pxd's in multi-phase sampled-data circuits.) According to the invention, the novel system and method introduce delays naturally induced by routing (preceding stages get the same clocks by alternating the phases only from the following stages. As a result of the logically occurring delays, the non overlapping times between phases can be kept minimal so as to tolerate the skews between any two, consecutive stages.

1. A clocking system driving a plurality of consecutive circuit phase operations, comprising:
means for generating a clock signal;
means for transmitting the clock signal to one circuit phase operation; and
means for transmitting another clock signal to a previous circuit phase operation.

2. A clocking system according to claim 1, wherein the clocking system is adaptable to a series of consecutive circuit phase operations that operate consecutively in time; wherein the means for transmitting the clock signal is configured to transmit the clock signal to the last consecutive circuit phase operation; and wherein each circuit phase includes means for transmitting a clock signal to a previous circuit phase operation.

3. A clocking system according to claim 1, wherein the clocking system is adaptable to a series of consecutive circuit phase operations that operate consecutively in time; wherein the means for transmitting the clock signal is configured to transmit the clock signal to the last consecutive circuit phase operation; and wherein each circuit phase includes means for transmitting a clock signal to a previous circuit phase operation after completion of a current circuit phase operation.

4. A clocking system according to claim 1, wherein the clocking system is adaptable to a series of consecutive circuit phase operations that operate consecutively in time; wherein the means for transmitting the clock signal is configured to transmit the clock signal to one of the consecutive circuit phase operations; and wherein each circuit phase includes means for transmitting a clock signal to a circuit phase operation that occurs previously in time after completion of a current circuit phase operation.

5. A clocking system according to claim 1, wherein the clocking system is adaptable to a series of consecutive circuit phase operations that operate consecutively in time; wherein the means for transmitting the clock signal is configured to transmit the clock signal to one of the consecutive circuit phase operations; and wherein each circuit phase includes means for transmitting a clock signal to a circuit phase operation that occurs previously in time.

6. A clocking system according to claim 5 wherein the means for transmitting a clock signal to a circuit phase that occurs previously in time is configured to transmit a clock signal that is an inverted version of the clock signal received by a current circuit phase operation and is transmitted after completion of a current circuit phase operation.

7. A clocking system according to claim 1, wherein the clocking system is adaptable to a series of consecutive circuit phase operations that operate consecutively in time; wherein the means for transmitting the clock signal is configured to transmit the clock signal to the last consecutive circuit phase operation; and wherein each circuit phase includes means for transmitting a clock signal to a previous circuit phase operation.

8. A clocking system for use in an integrated circuit having a plurality of consecutive circuit phase operations, comprising:
a clock driver configured to generate a clock signal;
a clock output configured to transmit the clock signal to one circuit phase operation; and
a circuit phase operation clock output configured to transmit another clock signal to a previous circuit phase operation.

9. A clocking system according to claim 8, wherein the clocking system is adaptable to a series of consecutive circuit phase operations that operate consecutively in time; wherein the clock output is configured to transmit the clock signal to the last consecutive circuit phase operation; and wherein each circuit phase includes an operation clock output configured to transmit a clock signal to a previous circuit phase operation.

10. A clocking system according to claim 8, wherein the clocking system is adaptable to a series of different consecutive circuit phase operations that operate consecutively in time; wherein the clock output is configured to transmit the clock signal to the last consecutive circuit phase operation; and wherein each circuit phase includes an operation clock output configured to transmit a clock signal to a previous circuit phase operation.

11. A clocking system according to claim 10, wherein the different consecutive circuit phase operations includes one of a pixel circuit, a sample and hold circuit, an amplifier circuit, a programmable amplifier circuit, an analog to digital converter and other circuit components.

12. A clocking system according to claim 8, wherein the clock driver is configured to generate a first clock signal and a corresponding first inverted clock signal, wherein the clock output is configured to transmit the first clock signal and first inverted clock signal to the one circuit phase operation, and wherein the circuit phase operation clock output is configured to transmit a second clock signal and a second inverted clock signal to a previously occurring circuit phase operation in the plurality of consecutive circuit phase operations.

13. A clocking system according to claim 8, wherein the clock driver is configured to generate a first clock signal and a corresponding first inverted clock signal, wherein the clock output is configured to transmit the first clock signal and first inverted clock signal to the one circuit phase operation, and wherein the circuit phase operation clock output is configured to transmit a second clock signal that is an inverted version of the first clock signal and a second inverted clock signal that is an inverted version of the first inverted clock signal to a previously occurring circuit phase operation in the plurality of consecutive circuit phase operations.

14. A clocking system according to claim 8, wherein the clocking system is adaptable to a series of consecutive circuit phase operations that operate consecutively in time, wherein the clock driver is configured to generate a first clock signal and a corresponding first inverted clock signal, wherein the clock output is configured to transmit the first clock signal and first inverted clock signal to the one circuit phase operation, and wherein the circuit phase operation clock output is configured to transmit a second clock signal and a second inverted clock signal to a previously occurring circuit phase operation in the plurality of consecutive circuit phase operations.

15. A clocking system according to claim 8, wherein the clocking system is adaptable to a series of consecutive circuit phase operations that operate consecutively in time, wherein the clock driver is configured to generate a first clock signal and a corresponding first inverted clock signal, wherein the clock output is configured to transmit the first clock signal and first inverted clock signal to the last of a series of consecutively operating circuit phase operations, and wherein the last occurring circuit phase operation in the series of consecutively operating circuit phase operations includes the circuit phase operation clock output and is configured to transmit a second clock signal that is an inverted version of the first clock signal and a second inverted clock signal that is an inverted version of the first inverted clock signal to a previously occurring circuit phase operation.

16. A clocking system according to claim 8, wherein the clocking system is adaptable to a series of different consecutive circuit phase operations that operate consecutively in time, where the previous circuit phase operation operates previously in time from the one circuit phase operation.

17. A clocking system according to claim 8, wherein the clocking system is adaptable to a series of different consecutive circuit phase operations that operate consecutively in time, where the previous circuit phase operation operates previously in time from the one circuit phase operation, and wherein the circuit phase operation clock output is configured to transmit another clock signal to a previous circuit phase operation after the completion of the operation of the one circuit phase operation.

18. A clocking system according to claim 8, wherein the clocking system is adaptable to a series of different consecutive circuit phase operations that operate consecutively in time, the system comprising a first circuit phase circuit having a circuit phase operation clock output configured to transmit a second clock signal to a second circuit phase operation that operates to previously in time in operation of the consecutive circuit phase operations; wherein the first circuit phase operation clock output is configured to transmit a second clock signal to the second circuit phase operation after the completion of the operation of the first circuit phase operation; the system further comprising a second circuit phase operation clock output generated from the second circuit phase operation configured to transmit a third clock signal to a third circuit phase operation that occurs previous to the second circuit phase operation.

19. A method of clocking a system for use in an integrated circuit having a plurality of consecutive circuit phase operations, comprising:
generating a clock signal;
transmitting the clock signal to one circuit phase operation; and
transmitting another clock signal from the one circuit phase operation to a previous circuit phase operation.

20. A method according to claim 19, wherein the clocking system is adaptable to a series of consecutive circuit phase operations that operate consecutively in time; the method further comprising transmitting the clock signal to the last consecutive circuit phase operation; and transmitting a clock signal from each phase to a previous circuit phase operation of each circuit phase operation.

21. A method according to claim 19, wherein the clocking system is adaptable to a series of different consecutive circuit phase operations that operate consecutively in time, where the previous circuit phase operation operates previously in time from the one circuit phase operation, the method further comprising transmitting another clock signal to a previous circuit phase operation after the completion of the operation of the one circuit phase operation.
